(19) United States
(12) Patent Application Publication
(10) Pub. No.: US 2004/0250660 A1
(43) Pub. Date: Dec. 16, 2004

(54) Spark-plug sockets for headers

(76) Inventor: Scott J. Rogers, Murrieta, CA (US)

Correspondence Address: SCOTT J ROGERS, 26793 MADISON AVE #101, MURRIETA, CA, 92562, US

(21) Appl. No.: 10/462,175

(22) Filed: Jun. 16, 2003

(51) Int. Cl. B25B 13/00

(52) U.S. Cl. 81/124.2

(57) ABSTRACT

A dedicated tool for the sole pupose of servicing spark-plugs on internal combustion engines with exhaust headers or obstructions where a tradiional spark-plug socket fails to perform. A single body tool, designed in multiple lengths. Designed as a multi-piece tool system. Each tool body contains an internal hex to mate with the appropriate sized spark-plug. Opposite end contains an external hex to allow an open-end or closed-end wrench to be used to tighten or loosen the spark-plug requiring service. The length of the external hex is critical to the effectiveness of the socket. The long series sockets incorporate a ⅜″ square drive to allow the socket to be used as a traditional spark-plug socket. All sockets contain a vertical mill slot to shorten the effective length of each socket. The vertical mill slot is also extremely critical to the effectiveness of the tool system. The vertical mill slot will allow up to a 90 degree installation angle. The center bore is a precise size to help guide the socket in relation to the spark-plug to avoid ceramic insulator damage.

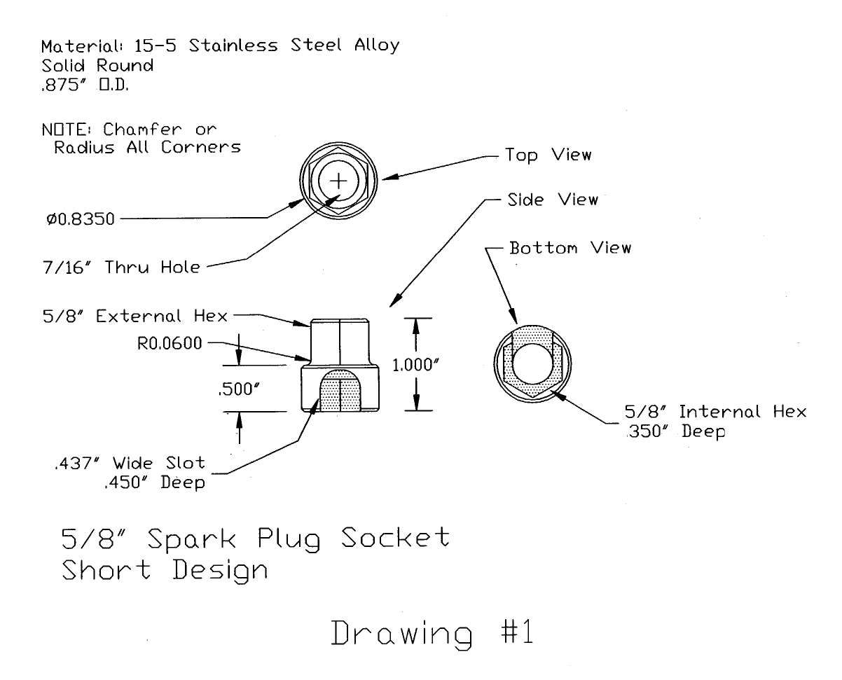

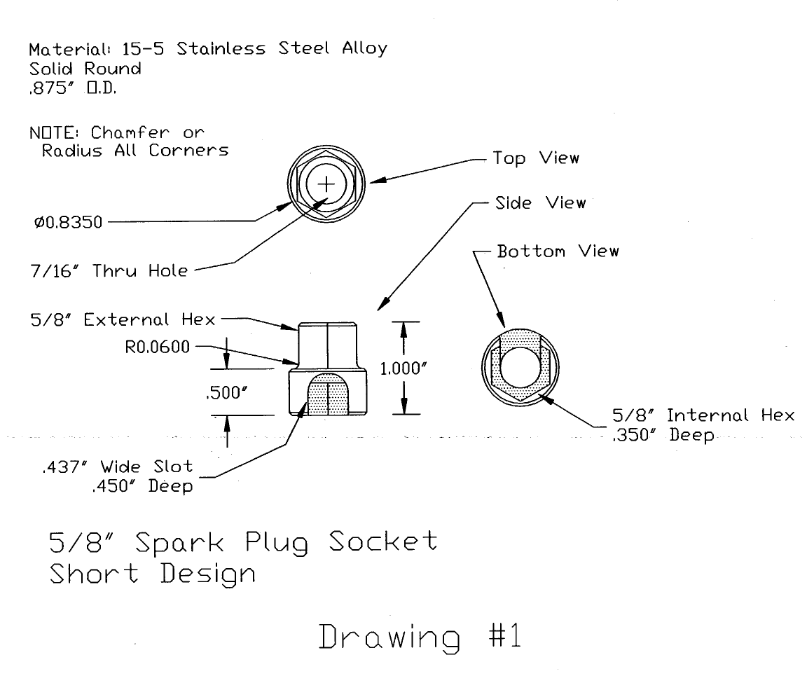

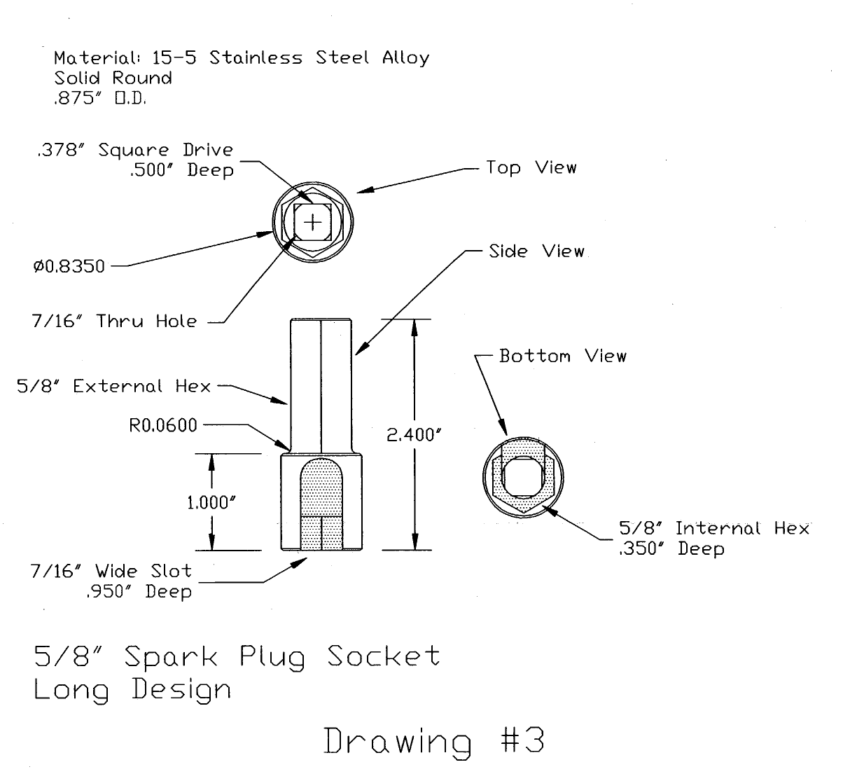

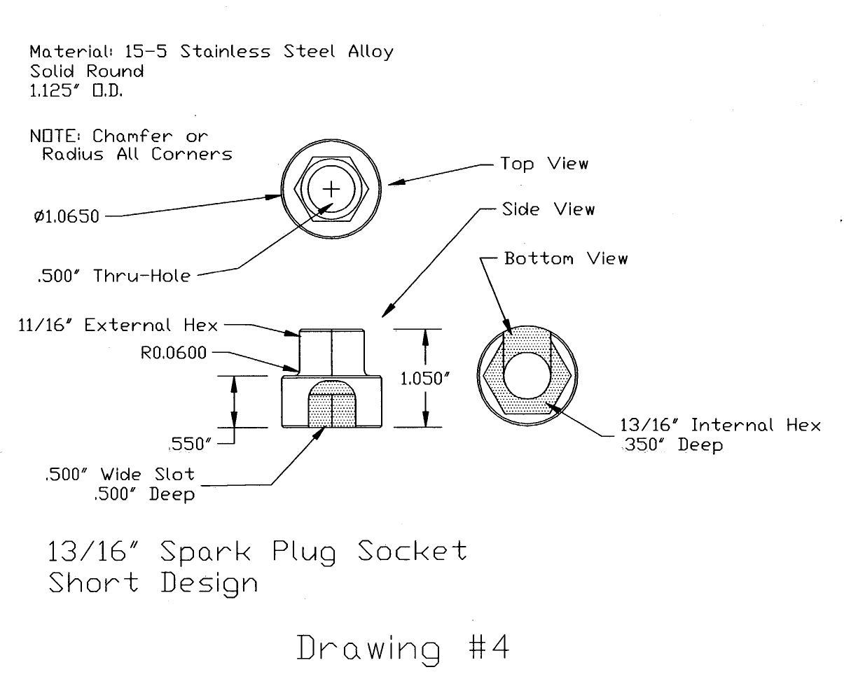

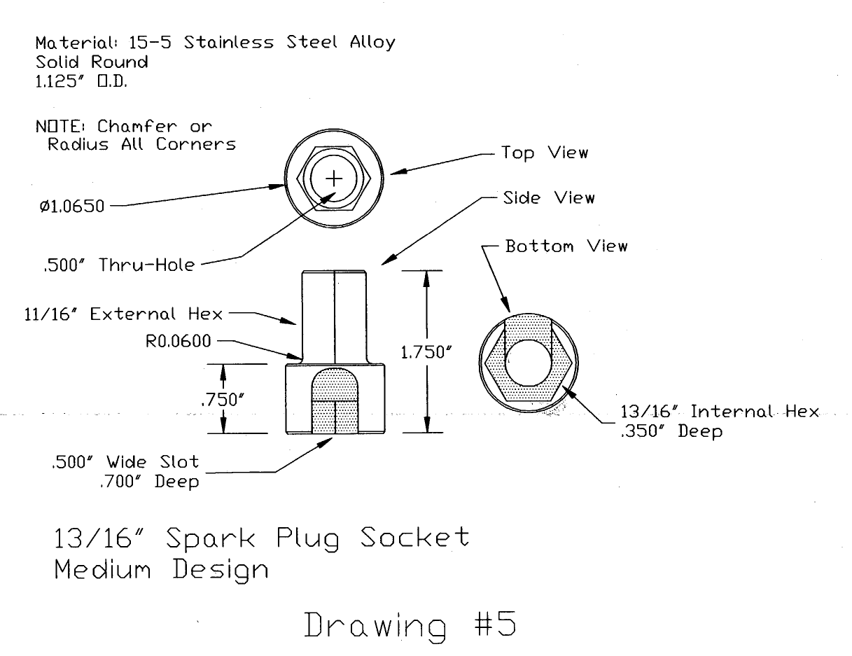

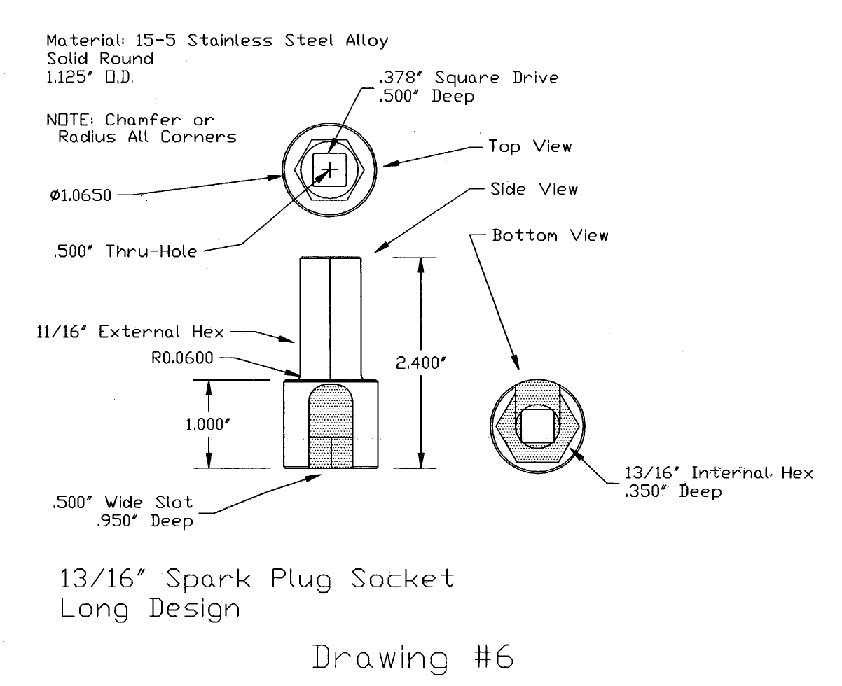

### BACKGROUND OF THE INVENTION

The background of the invention comes from a long-time need to quickly service spark-plugs on conventional internal combustion engines with tight quarters or performance exhaust systems. Presently there is not an acceptable tool to service spark-plugs on many applications, primarily with exhaust headers. Many mechanics have dreaded having to remove and install spark-plugs with exhaust headers due to the fact the loosening the exhaust headers is, in many cases, the only viable service method. To loosen the exhaust headers can take from 5 minutes to an hour or more. Myself, being an automotive mechanic for nearly 25 years, have encountered this scenario on many occassions. That is why I decided to design, produce and market this invention.

In the automotive tool industry a spark-plug socket has been a standard item in every mechanics tool box. They are designed specifically for servicing spark-plugs due the spark-plugs peculiar size and shape. The special design is also neccessary because of the fragile nature of spark-plugs from the way they are produced using a ceramic or porcelan body. If the body is fractured, which is an insulator for the center electrode, then a spark leak will occur causing an engine miss and can eventually create engine damage if not repaired. Take a look in every tool companies catalogue and you'll find a variety of dedicated spark-plug sockets. These will work fine in normal applications. Put a set of performance or race car style exhaust headers onto the engine and those standard sockets will fail to perform the required task in many instances. Even if, on a normal V-8 engine, a mechanic can remove 7 spark-plugs with ease with the traditional spark-plug sockets but cannot service the eighth, where does that leave him? It leaves him in an extremely bad position. The only option is to remove the exhaust header to gain clearance for the traditional socket. What a waste of time!

With the new invention of Spark-Plug Sockets for Headers, these nearly impossible service situations will become routine.

### BRIEF SUMMARY OF THE INVENTION

Spark-Plug Sockets for Headers are designed as a multi-tool system. The different size tools will allow the mechanic to decide which tool is most appropriate for the job. The varying lengths and cuts will allow spark-plug servicing in nearly any engine/exhaust combination without the need for exhaust system removal. The tool system presently consists of a total of 6 sockets. Three ⅝″ internal hex and three 13/16″ internal hex. The three ⅝″ internal hex sockets come in three lengths. The three 13/16″ internal hex sockets also come in three varying lengths. The sockets consist of five standard hand tool elements. The elements are an internal hex, an outer hex, a thru-bore, a vertical mill slot and varying length. However it's the combination of all five elements that produce a truly unique and powerful tool. In the final form, this tool becomes a mechanics dream.

### CROSS-REFERENCE TO RELATED PATENTS

1: U.S. Pat. No. 2,570,779—Reversible Ratchet Wrench.

2: U.S. Pat. No. 5,009,343—Automotive Tool.

3: U.S. Pat. No. 5,074,172—Spark Plug Tool.

4: U.S. Pat. No. 5,074,1 73—Spark Plug Tool.

### DETAILED DESCRIPTION OF THE INVENTION

Manufacture of the Invention

The current process to build the Spark-Plug Sockets for Headers begins with one of either two materials 4340 steel aircraft alloy or 15-5 stainless steel aircraft alloy. However, any suitable material may be used. Both materials are from solid round material. The first step is to part and turn the material per design specifications using industry standard machining processes and equipment to obtain correct length and O.D. The next phase is to bore the dual center inside diameters to proper design specifications using industry standard machining processes and equipment. The next procedure is to cut the external hex using industry standard machining processes and equipment. The following procedure is to cut the internal hex to proper design dimensions. This can be accomplished by either broaching or electronic disentegration equipment [EDM]. Again industry standard machining processes and equipment would be used. At this point the unfinished socket will need to be heat-treated to strengthen the material to acceptable levels. 180,000-200,000 psi tensile strength is a suitable level for the two materials stated above. Actual heat-treat method is determined by the exact type of material used. The final operation for the stainless-steel material is to mill the vertical slot in the internal hex using industry standard machining processes and equipment. The vertical slot milling operation must be done after the heat-treat process to be able to maintain the design tolerance of the socket. A quick polish and deburring operation will give a nice finish. For the 4340 steel alloy material, after the vertical milling operation and polish and deburring operation, the socket will need to nitrided to inhibit rust using an industry standard nitriding method. The socket will now be complete and ready for use.

Using the Invention:

The use of the Spark-Plug Sockets for Headers is very staight forward. However, due to the design of the sockets, the mechanic will notice increased capabilities when compared to traditional spark-plug sockets. When would a mechanic need to use one of the Spark-Plug Sockets for Headers? The answer is when a traditional spark-plug socket fails to be able to be used for installation or removal of a spark plug. The sockets may also be designed and used for any other general application in which the design will allow effective use. If a mechanic could not use an open-end or closed-end wrench to install or remove a spark-plug would promote another use the sockets. The reason a traditional spark-plug socket would fail to perform would be due to the fact that either the exhaust pipe or other obstacle would be hindering the ability of the spark-plug socket to be installed. Traditional spark-plug sockets are designed to be installed on the same axis as the spark-plugs center-line. This means that the traditional spark-plug socket can only deflect a few degrees from center and still be able to be installed. For this reason, if an exhaust header was installed and one of the exhaust tubes or another obstacle is in the way of the center-line of the spark-plug axis then the traditional spark-plug socket is useless. Also on many cylinder heads a traditional open-end or closed-end wrench is not usable because the spark-plug external hex which is used for tightening or loosening of the spark-plug itself is counter-sunk, locating the external hex below the face of the cylinder head. The traditional wrench just can't reach the external hex.

So the first point of using Spark-Plug Sockets for Headers is when no other tool will work short of removing the exhaust headers or obstruction.

Spark-plug removal: The procedure for spark-plug removal is as follows. The mechanic will first make sure that the engine area to be worked on is cooled down enough to allow service or that the appropriate heat protection is used. Removal of the ignition wire is next, leaving the spark-plug ready for removal. The mechanic will need to determine where he can access the Spark-Plug Socket for Headers external hex once installed using the desired wrench, either open-end or closed-end. This access point will dictate which socket to use. The differing lengths that the Spark-Plug Sockets for Headers is designed in is to allow an open-end or closed-end wrench through the header tubes at any point that would allow sufficient access to engage the sockets external hex. No ratchet or air tool is required. The Spark-Plug Sockets for Headers are designed to be used solely with an open-end or closed-end wrench, although the long socket is made with a square-drive to allow the socket to be used as a traditional spark-plug socket using a hand ratchet. Sometimes the access point may be right up against the cyliner head requiring the short socket. Sometimes it might be at the approximate midpoint of the spark-plug, requiring the mid-length socket. Last of all, the only access might be at the tip of the spark-plug where the spark-plug boot is attachted. This area would require the long socket.

Once the correct length socket is chosen it would then be time to install the Spark-Plug Socket for Headers on the spark-plug to be serviced. The way the socket is designed is to be able to slide the vertical mill of the socket at up to 90 degrees [perpendicular] onto the tip of the spark-plug needing service. The socket would then be rotated until the center-line of both the spark-plug and the socket were parallel.

Note: This is one of the key points of the design of the socket. The vertical mill slot on the socket shortens the effective length of the socket. A 2″ long socket with a 1″ vertical mill will seem to the mechanic like he is working with only a 1″ long socket. This design will allow much greater access than a full body design. Although the vertical mill does weaken the socket, the torque load for the socket is still above 100 ft lbs. using the ⅝″ design. The torque range for todays conventional spark-plugs is between 15-22 ft lbs. This is an average of a 5:1 safety loading which exceeds the current design ratio of 4:1.

The socket would now be pushed up to engage the spark-plugs external male hex to the sockets internal female hex. Slight twisting of the socket may be needed to mesh the two. A ⅝″ open-end or closed-end wrench will be used at this point to feed through the exhaust header tubing to gain access to the sockets external hex with whatever substaintial opening the mechanic may find. This may be from the topside or the bottom side of the engine, where-ever the access is best. The wrench will be used to rotate the spark-plug counter-clockwise. In many instances once the spark-plug is broke free it can usually be turned out the rest of the way by hand. Total time to remove a spark-plug may take as little as 5-10 seconds. Even if the spark-plug is tight and needs to be turned out a flat or two at a time that may still only take a minute or two, it still beats removing an entire exhaust header to gain enough access to remove the spark-plug using a traditional spark-plug socket. Spark-plug removal is complete.

Spark-plug installation: Installation is also very simple using the Spark-Plug Sockets for Headers. First check the spark-plug for correct gap. Then slide the socket on the spark-plug to be installed. Feed the spark-plug and socket down to the respective spark-plug hole. Start the spark-plug by hand, rotating clockwise. Turn in as far as possible by hand. If the plug is not seated continue using either an open-end or closed-end wrench. Once seated tighten an additional 1/16 to ⅛ turn. Slide the socket off of the spark-plug plug and rotate through the vertical mill as far as necessary to finish removal. Re-install the ignition wire boot end. Spark-plug installation is complete.

I claim the following:

1: A tool embodiment encompassing the following features.

2: An external hex that is on the center-line of the long-axis of the tool embodiment, starting at one end of the tool and proceeds approximately to the mid-point, 50%, of the tool embodiment.

3: A internal hex that is opposite of and of the same center-line as the external hex.

4: A thru-bore that is on the long-axis center-line and continues thru the entire tool embodiment.

5: The thru-bore inside diameter is matched to the outer diameter of a spark-plugs extended ceramic body.

6: A vertical mill slot cut from the bottom of the internal-hex following the long axis center-line continuing up to approximately the mid-point of the tool embodiment.

7: On the long tools, 2″ or longer, an internal ⅜″ square-hole on the same side as the external-hex and of the same center-line, to allow the attachment of a common ⅜″ drive ratchet.
